(19) United States
(12) Patent Application Publication
(10) Pub. No.: US 2018/0251290 A1
(43) Pub. Date: Sep. 6, 2018

(54) BRUSH CONTAINER

(71) Applicant: RUNSEA TECHNOLOGY CO., LTD., HSINCHU CITY (TW)

(72) Inventors: Yung-Chiang LIN, HSINCHU CITY (TW); Shih-Chieh HSU, HSINCHU CITY (TW); Chia-Fu HSU, HSINCHU CITY (TW)

(21) Appl. No.: 15/895,550

(22) Filed: Feb. 13, 2018

(30) Foreign Application Priority Data
Mar. 3, 2017 (TW) 106203014

(51) Int. Cl. B65D 85/38; B65D 25/00; A46B 17/08

(52) U.S. Cl. CPC B65D 85/38; G02F 2001/1316; A46B 17/08; B65D 25/005

(57) ABSTRACT

A brush container includes a box and two support members. The box has a U-shaped frame with two ends each having an end cover; hence, a storage space for containing a brush is defined between the U-shaped frame and two end covers. An upper cover for sealing the storage space is disposed on the top surface of the U-shaped frame. The U-shaped frame has an inner panel, an outer panel corresponding in position to the inner panel, and rib panels disposed between the inner and outer panels to allow a hollowed-out region to be defined between the inner and outer panels and two adjacent rib panels. Hence, despite being lightweight, the box has high structural strength. The two support members are slidably disposed in the storage space. Since their positions are adjustable according to the length of the brush, the two support members provide optimal support to the brush.

### BACKGROUND OF THE INVENTION

1. Technical Field

The present invention relates to brush containers and, more particularly, to a brush container which has high structural strength and is lightweight so as to deliver and store a brush conveniently.

2. Description of Related Art

A brush is a tool indispensable to the washing of a glass substrate. Since the surface of the brush is in direct contact with the glass substrate, the brush is effective in removing foreign bodies from the surface of the glass substrate. However, long use of the brush causes the dwindling of the cleaning function thereof or even causes the foreign bodies to adhere to the surface of the brush and thus become a source of contamination in various manufacturing processes. Therefore, every brush in use must be changed at the end of a specific period of service thereof in order to provide high-quality cleaning service.

The length of brushes increases with the ever-increasing size thereof. Furthermore, newly manufactured brushes are stored in containers. As soon as the containers are opened, the new brushes therein are available for use. However, conventional containers are seldom designed to be lightweight, and in consequence workers take a lot of efforts to deliver the containers. Therefore, conventional containers still have room for improvement in structure.

### BRIEF SUMMARY OF THE INVENTION

It is an objective of the present invention to provide a brush container which has high structural strength and meets lightweight requirements.

In order to achieve the above and other objectives, the present invention provides a brush container which comprises a box and a support unit. The box has a U-shaped frame, two end covers and an upper cover. The U-shaped frame has an inner panel, an outer panel and rib panels. The inner and outer panels correspond in position to each other and are separated by a predetermined distance, allowing two parallel rail portions to be disposed on a bottom surface of the inner panel, with the rib panels spaced apart and disposed between the inner and outer panels to allow a hollowed-out region to be defined between the inner and outer panels and two adjacent said rib panels. Hence, despite being lightweight, the U-shaped frame has high structural strength. The two end covers are disposed at two opposite ends of the U-shaped frame, with a storage space defined between the U-shaped frame and the two end covers and adapted to contain a brush. The upper cover is demountably disposed on a top surface of the U-shaped frame to seal the storage space. The support unit has two support members. The two support members are disposed in the storage space of the box. A top edge of each support member has an upper support recess for receiving an end of the brush, and a bottom edge of each support member has two opposing lower guide slots slidably disposed at the rail portions of the U-shaped frame of the box such that the two support members are movable within the storage space and relative to the box to the extent corresponding to the length of the brush.

Preferably, two ends of the outer panel of the U-shaped frame each have a first engaging portion and a groove positioned proximate to the first engaging portion, whereas two opposing lateral edges of the upper cover each have a second engaging portion, such that the second engaging portions are engaged with the first engaging portions and slidably embedded in the grooves. Therefore, the assembly process of the brush container involves applying a downward press on the upper cover such that the second engaging portions of the upper cover become engaged with the first engaging portions of the U-shaped frame. To demount the upper cover, a user only needs to pull the upper cover in the direction of extension of the grooves or lift the upper cover directly.

Preferably, two opposing outer sides of the U-shaped frame each sink toward the storage space to form a grip recess which the user inserts his/her finger into in order to grip the brush container, thereby enhancing the ease of delivery of the brush container.

Preferably, the support members each have two opposing pin holes, with a pin penetratingly disposed in each said pin hole, whereas a cord is fittingly disposed between two adjacent said pins and adapted to bind an end of the brush, so as to enhance the stability of the brush in the course of delivery thereof.

Preferably, a top edge of each said support member further has two opposing upper guide slots, and the support members are engaged with the rail portions of the U-shaped frame of the box by the two upper guide slots or the two lower guide slots selectively.

Preferably, the bottom edge of each said support member has a lower support recess, and each said support member receives an end of the brush by the upper support recess or the lower support recess selectively, wherein the sizes and shapes of the upper and lower support recesses are identical or different, depending on the diameter of the brush.

The detailed structures, features, assembly or use of a brush container provided by the present invention are illustrated with embodiments and described below. However, persons skilled in the art understand that the description and exemplary specific embodiments of the present invention are illustrative of the present invention rather than restrictive of the claims of the present invention.

### BRIEF DESCRIPTION OF THE SEVERAL VIEWS OF THE DRAWINGS

FIG. 1 is a perspective view of a brush container of the present invention;

FIG. 2 is an exploded view of the brush container of the present invention;

FIG. 3 is a cutaway view of the brush container of the present invention; and

FIG. 4 is a transverse cross-sectional view of the brush container of the present invention.

### DETAILED DESCRIPTION OF THE INVENTION

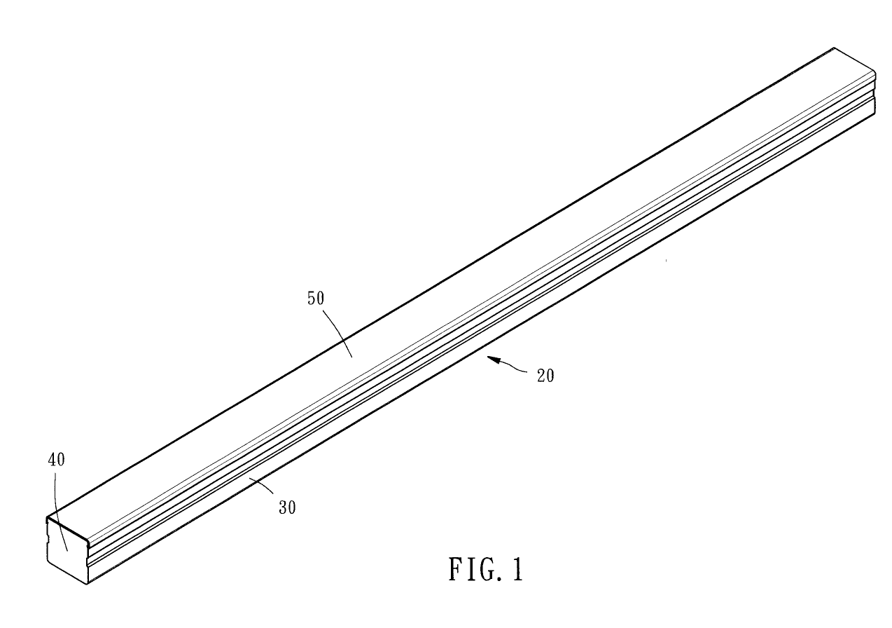

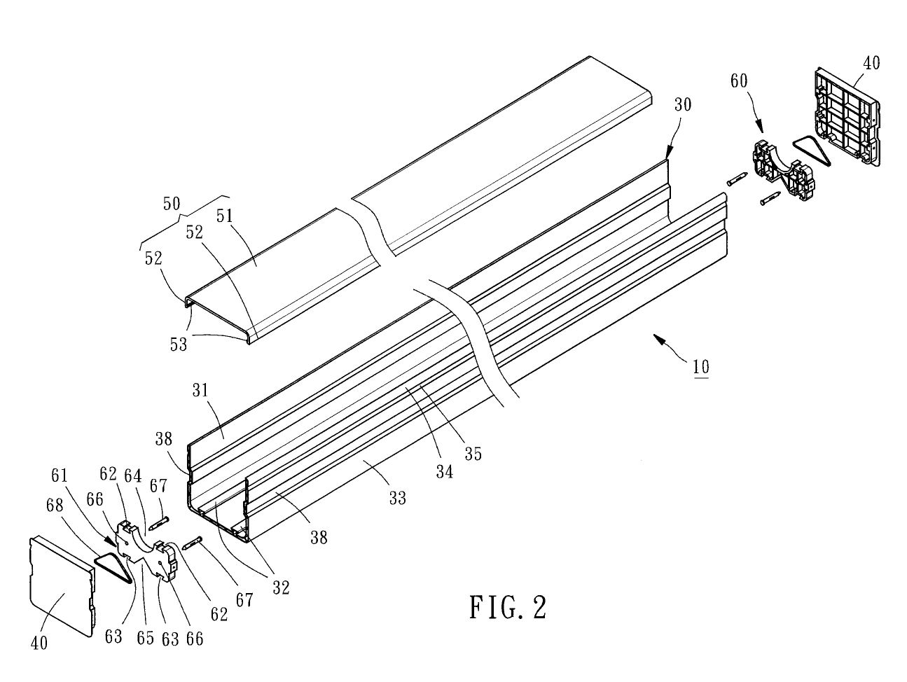

Referring to FIG. 1 and FIG. 2, a brush container 10 of the present invention comprises a box 20 and a support unit 60.

The box 20 has a U-shaped frame 30, two end covers 40 and an upper cover 50.

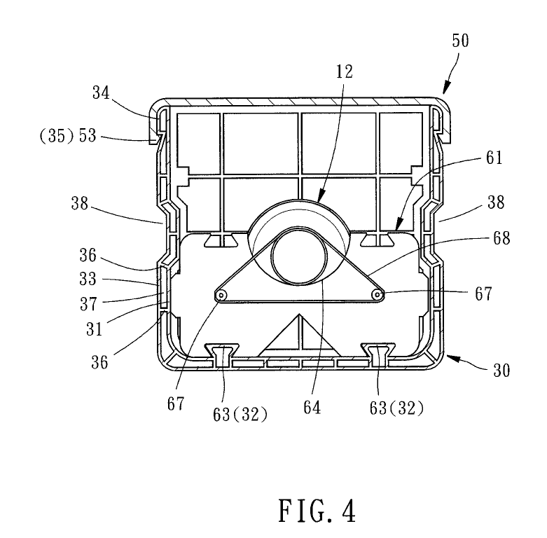

As shown in FIG. 2 and FIG. 4, the U-shaped frame 30 has an inner panel 31, an outer panel 33 and rib panels 36. The inner and outer panels 31, 33 correspond in position to each other and are separated by a predetermined distance. The rib panels 36 are paired, spaced apart, and connected between the inner and outer panels 31, 33 to allow a hollowed-out region 37 to be defined between the inner and outer panels 31, 33 and two adjacent said rib panels 36. A bottom surface of the inner panel 31 has two parallel rail portions 32. A top end of the outer panel 33 has two opposing first engaging portions 34 and two opposing grooves 35. A top end of each first engaging portion 34 is connected to a top end of the inner panel 31. The grooves 35 are positioned proximate to a bottom end of the first engaging portion 34.

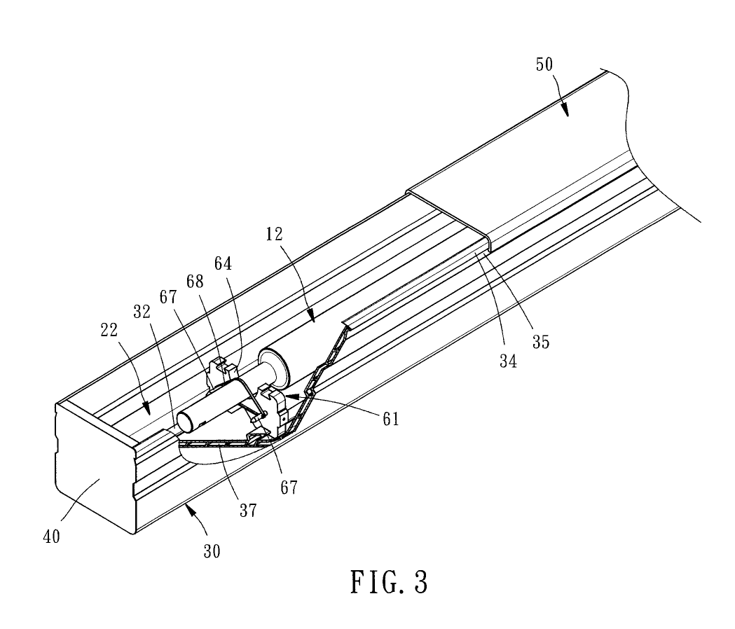

As shown in FIG. 2 and FIG. 3, two end covers 40 are disposed at two opposite ends of the U-shaped frame 30, whereas a storage space 22 is defined between the U-shaped frame 30 and the two end covers 40 and adapted to contain a brush 12.

As shown in FIG. 2 and FIG. 4, the upper cover 50 has a cover panel 51 and two opposing wing panels 52. Top ends of the two wing panels 52 are connected to two opposing lateral edges of the cover panel 51. Bottom ends of the two wing panels 52 each have a second engaging portion 53. Therefore, when the upper cover 50 is mounted on the U-shaped frame 30, the second engaging portions 53 of the two wing panels 52 are engaged with the first engaging portions 34 of the U-shaped frame 30 and embedded in the grooves 35 of the U-shaped frame 30 such that the cover panel 51 of the upper cover 50 seals the storage space 22. As shown in FIG. 3, to demount the upper cover 50, a user pulls the upper cover 50 out of one end of the upper cover 50 or lifts the upper cover 50 directly. The present invention is herein exemplified by a pull. The second engaging portions 53 of the upper cover 50 move along the grooves 35 of the U-shaped frame 30 until they escape from the grooves 35. As soon as the escape happens, the second engaging portions 53 of the upper cover 50 disengage from the first engaging portions 34 of the U-shaped frame 30, thereby demounting the upper cover 50.

To facilitate the delivery of the box 20, two opposing outer sides of the U-shaped frame 30 each have a grip recess 38. As shown in FIG. 2 and FIG. 4, the grip recesses 38 are formed by sinking the outer panel 33 and the inner panel 31 toward the storage space 22. The user inserts his/her fingers into the grip recesses 38 in order to grip the brush container 10, thereby enhancing the ease of delivery of the brush container 10.

Referring to FIGS. 2-4, the support unit 60 has two support members 61. The top edge of each support member 61 has two opposing upper guide slots 62. The bottom edge of each support member 61 has two opposing lower guide slots 63. The two support members 61 are engaged with the rail portions 32 of the U-shaped frame 30 of the box 20 by the upper guide slots 62 or the lower guide slots 63 selectively such that the two support members 61 are movable within the storage space 22 relative to the box 20. In this embodiment, the two support members are engaged with the rail portions 32 of the U-shaped frame 30 of the box 20 by the lower guide slots 63. The top edge of each support member 61 has an upper support recess 64 disposed between two upper guide slots 62. The bottom edge of each support member 61 has a lower support recess 65 disposed between the two lower guide slots 63. Selectively, the upper support recesses 64 or the lower support recesses 65 of the two support members 61 receive the brush 12 such that the two support members 61 jointly support the brush 12. In this embodiment, the upper support recesses 64 of the two support members 61 receive the brush 12.

The upper and lower support recesses 64, 65 are of identical or different sizes and shapes. However, in this embodiment, to meet various size-related requirements of the brush 12, the upper and lower support recesses 64, 65 are of different sizes and shapes. As shown in FIG. 2, the upper support recesses 64 are semicircular, whereas the lower support recesses 65 are triangular; hence, the size of the brush 12 received by the upper support recesses 64 is greater than the size of the brush 12 received by the lower support recesses 65. Therefore, the direction in which the support members 61 are mounted depends on the size of the brush 12.

Referring to FIGS. 2-4, each support member 61 has two opposing pin holes 66 between the upper and lower guide slots 62, 63. A pin 67 is insertedly disposed in each pin hole 66. A cord 68 is fittingly disposed between two adjacent pins 67 and adapted to bind an end of the brush 12; hence, in the course the delivery of the brush 12, the brush 12 is unlikely to hit the box 20 and get damaged.

In conclusion, the brush container 10 of the present invention is characterized by: the hollowed-out regions 37 whereby the box 20 is rendered lightweight but still has high structural strength; the two slidable support members 61 whose positions are adjustable according to the length of the brush 12 so as to provide optimal support to the brush 12; and the cord 68 capable of binding an end of the brush 12 such that the brush 12 has high structural stability and thus no chance of getting damaged while being stored and delivered.

What is claimed is:

1. A brush container, adapted for containing a brush, the brush container comprising:
a box having a U-shaped frame, two end covers and an upper cover, with the U-shaped frame having an inner panel, an outer panel and rib panels, the inner and outer panels corresponding in position to each other and being separated by a predetermined distance, allowing two parallel rail portions to be disposed on a bottom surface of the inner panel, with the rib panels spaced apart and disposed between the inner and outer panels to allow a hollowed-out region to be defined between the inner panel, the outer panel and two adjacent said rib panels, wherein the two end covers are disposed at two opposite ends of the U-shaped frame, with a storage space defined between the U-shaped frame and the two end covers and adapted to contain the brush, the upper cover being demountably disposed on a top surface of the U-shaped frame to seal the storage space; and
a support unit having two support members disposed in the storage space of the box, wherein a top edge of each said support member has an upper support recess for receiving an end of the brush, and a bottom edge of each said support member has two opposing lower guide slots slidably disposed at the rail portions of the U-shaped frame of the box such that the two support members are movable within the storage space relative to the box.

2. The brush container of claim 1, wherein two ends of the outer panel of the U-shaped frame each have a first engaging portion and a groove positioned proximate to the first engaging portion, whereas two opposing lateral edges of the upper cover each have a second engaging portion, such that the second engaging portions are engaged with the first engaging portions and slidably embedded in the grooves.

3. The brush container of claim 1, wherein two opposing outer sides of the U-shaped frame each sink toward the storage space to form a grip recess.

4. The brush container of claim 1, wherein the support members each have two opposing pin holes, with a pin penetratingly disposed in each said pin hole, whereas a cord is fittingly disposed between two adjacent said pins and adapted to bind an end of the brush.

5. The brush container of claim 1, wherein a top edge of each said support member further has two opposing upper guide slots, and the support members are disposed in the rail portions of the U-shaped frame of the box by one of the upper and lower guide slots selectively.

6. The brush container of claim 1, wherein the bottom edge of each said support member has a lower support recess, and each said support member receives an end of the brush by one of the upper and lower support recesses selectively.

7. The brush container of claim 6, wherein the upper and lower support recesses have identical sizes.

8. The brush container of claim 6, wherein the upper and lower support recesses have different sizes.

9. The brush container of claim 6, wherein the upper and lower support recesses have identical shapes.

10. The brush container of claim 6, wherein the upper and lower support recesses have different shapes.
